(19) United States
(12) Patent Application Publication
(10) Pub. No.: US 2025/0117392 A1
(43) Pub. Date: Apr. 10, 2025

(54) DATA PROCESSING DEVICE, AND METHOD FOR CONVERTING DATA

(71) Applicant: Robert Bosch GmbH, Stuttgart (DE)

(72) Inventors: Stefan Schueller, Adelsheim (DE); Timon Reich, Schwieberdingen (DE)

(21) Appl. No.: 18/729,438

(22) PCT Filed: Dec. 28, 2022
(86) PCT No.: PCT/EP2022/087927

§ 371 Date: Sep. 10, 2024

(30) Foreign Application Priority Data
Jan. 20, 2022 (DE) 10 2022 200 659.3

(51) Int. Cl. G06F 16/25

(52) U.S. Cl. CPC G06F 16/254

(57) ABSTRACT

A data processing device. The data processing device includes: an input interface configured to receive input data and extract raw data and information about a data structure according to which the raw data are structured; a generator configured to, for at least one data type used by the data structure, select a source code generation plugin, assigned to the data type, generate, using the selected source code generation plugin, conversion source code for converting the data type to a target format, combine the conversion source codes for converting the data types to the target format to form conversion source code for converting the data structure to the target format, and generate a conversion plugin for converting the data structure to the target format; and a converter configured to execute the conversion plugin and thus to convert the raw data to the target format.

### FIELD

The present invention relates to data processing devices and methods for converting data.

### BACKGROUND INFORMATION

Sensor data or log data that are recorded and transmitted are typically converted to suitable data formats for processing. Data conversion is the migration of recorded data between formats used by different systems to benefit from different strengths of different systems, to use data in different areas, and to exchange data with external parties.

For performance reasons, data can be recorded and transmitted, for example as raw data, i.e., the output format of the data conversion can be a very slim format that only makes it possible to separate and identify data blocks in the data stream. A receiver (i.e., a receiving data processing device) must then interpret these data according to complex data structures, for example for use of analysis software. In certain applications, for example when sending data from an embedded system, the computing resources in the sender (i.e., the data processing device that sends the data) are, for example, limited and the sender simply provides raw data as they accumulate, without specifically adapting them to the requirements of a receiver.

Receivers are desirable that are able to flexibly and efficiently process data from different sources that are structured according to different data structures.

### SUMMARY

According to various embodiments of the present invention, a data processing device is provided, including: an input interface configured to receive input data and to extract, from the input data, raw data and information about a data structure according to which the raw data are structured, wherein the data structure contains a plurality of data types, which are specified by the information; a generator configured, for at least one data type used by the data structure, to select a source code generation plugin, assigned to the data type, from a plurality of source code generation plugins, to generate, by means of the selected source code generation plugin, conversion source code for converting the data type to a target format, to combine the conversion source codes for converting the data types to the target format to form conversion source code for converting the data structure to the target format, and to generate, by means of compilation using the conversion source code for converting the data structure to the target format, a conversion plugin for converting the data structure to the target format; and a converter configured to execute the conversion plugin and thus to convert the raw data to the target format.

The data processing device according to the present invention described above clearly implements a bootstrap mechanism that enables it to receive data and to convert them to a desired format without having to provide a manually programmed conversion routine in advance for each data structure according to which the received data could be structured. The data processing device, on the other hand, builds a conversion routine for the data structures from data types that make up the data structures and from existing source code for converting the data types. This takes place, for example, by recursion in the processing of the data structures. A conversion routine only needs to be created once per data type. Even if the data structures used change rapidly (for example, when software in a vehicle control device is updated), the receiving data device (for example, a host for analyzing data from a vehicle) can process the raw data. In particular, this makes it possible for the effort on the part of the sending data processing device to remain low because it itself does not have to perform a conversion in order to provide the data in a specific data format (i.e., structured according to one or more specific data structures).

Only the source code generation plugins are provided in the generator, i.e., one plugin per data type (which should not or cannot be converted one-to-one) instead of plugins for all possible data structures. This makes it possible for the generator to access a set of conversion rules (for data types) and thus to generate the correct conversion program code for one or more data structures used. For data types that are used by the data structure and can be converted one-to-one, a generic conversion routine can be used, i.e., a separate source code generation plugin is not necessarily required for such data types (but generic conversion source code is used). For the data types that cannot be converted one-to-one (i.e., generically), a corresponding source code generation plugin is provided. The source code generation plugins are different for different (ones of these) data types. The term “at least one data type” thus refers, for example, to all data types for which a source code generation plugin is provided or which cannot be converted generically.

Various exemplary embodiments of the present invention are specified below.

Exemplary embodiment 1 is a data processing device as described above.

Exemplary embodiment 2 is a data processing device according to exemplary embodiment 1, wherein the information about the data structure specifies a syntax tree of the data structure.

This makes it possible to efficiently specify the used data structures in the information about the data structure (also referred to as meta-information).

Exemplary embodiment 3 is a data processing device according to exemplary embodiment 1 or 2, wherein the input data for each data structure of a plurality of data structures contain raw data structured according to the data structure, and the generator is configured to generate a corresponding conversion plugin for each data structure, and the converter is configured to ascertain, for extracted raw data, according to which data structure they are structured, and to execute the corresponding conversion plugin and thus to convert the raw data to the target format.

The converter is thus enabled to correctly convert raw data structured according to a plurality of data structures to the target format.

Exemplary embodiment 4 is a data processing device according to exemplary embodiment 3, wherein the generator is configured to assign a hash value to each conversion plugin, and wherein the converter is configured to ascertain and execute a conversion plugin for converting raw data structured according to one of the data structures, by forming a hash value of a syntax tree of the data structure and selecting the conversion plugin to which the formed hash value is assigned.

Using hashes of syntax trees makes it possible to simply generate unique identifiers and thus to simply select the correct conversion plugin for a data structure.

Exemplary embodiment 5 is a data processing device according to one of exemplary embodiments 1 to 4, wherein the raw data are measurement data, which are provided by a robot mechanism (e.g., read from its memory), and/or log data of the execution of a program on a robot mechanism.

This makes it possible for a robot mechanism (or an embedded system) to simply transmit measurement data or log data as raw data without having to adhere to a specific data format. This reduces the computational effort on the side of the robot mechanism, where computing resources are typically limited.

Exemplary embodiment 6 is a method for converting data, comprising receiving input data; extracting, from the input data, raw data and information about a data structure according to which the raw data are structured, wherein the data structure contains a plurality of data types, which are specified by the information; for at least one data type used by the data structure, selecting a source code generation plugin, assigned to the data type, from a plurality of source code generation plugins, generating, by means of the selected source code generation plugin, conversion source code for converting the data type to a target format, combining the conversion source codes for converting the data types to the target format to form conversion source code for converting the data structure to the target format, and generating, by means of compilation of the conversion source code for converting the data structure to the target format, a conversion plugin for converting the data structure to the target format; and executing the conversion plugin and thus converting the raw data to the target format.

Exemplary embodiment 7 is a computer program comprising instructions that, when executed by one or more processors, cause the one or more to carry out the method described above.

Exemplary embodiment 8 is a computer-readable medium storing instructions that, when executed by one or more processors, cause the one or more to carry out the method described above.

It should be noted that exemplary embodiments described in connection with the data processing device apply analogously to the method for converting data.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a vehicle according to an example embodiment of the present invention.

FIG. 2 illustrates a generator phase carried out by a generator, according to an example embodiment of the present invention.

FIG. 3 illustrates a conversion phase carried out by a converter, according to an example embodiment of the present invention.

FIG. 4 shows a flowchart representing a method for converting data according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects of the present invention.

Various examples are described in more detail below.

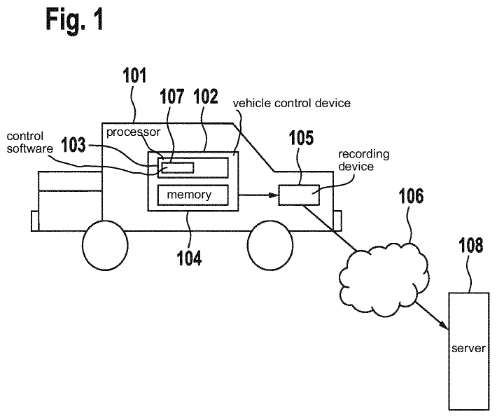

FIG. 1 shows a vehicle 101.

In the example of FIG. 1, a vehicle 101, for example a passenger car or truck, is provided with a vehicle control device (e.g., an electronic control unit (ECU)) 102.

The vehicle control device 102 comprises data-processing components, e.g., a processor (e.g., a CPU (central processing unit)) 103 and a memory 104 for storing control software 107, according to which the vehicle control device 102 operates, and data processed by the processor 103.

For example, the stored control software (computer program) comprises instructions that, when executed by the processor, cause the processor 103 to execute driver assistance functions or to collect data (sensor data or trip data) or even to control the vehicle autonomously.

By collecting data or through log data relating to the execution of the control software, the vehicle control device 102 generates an amount of raw data recorded by a recording device 105. For this purpose, the vehicle control device 102 can simply write to a common memory (e.g., the memory 104) and grant ownership rights to the recording device 105 (i.e., transmit the data to the recording device 105 without making a copy). From there, they can then be transmitted to a server 108 via a network 106. This can be done continuously or in a bundled manner, for example by means of a larger file that is transmitted when the vehicle 101 is in a garage.

In the case of a control device in a vehicle, the network 106 is a wireless network, for example. In case the control device of a stationary robot mechanism (e.g., for an industrial robot arm) transmits data, the network 106 is, for example, a wired network (e.g., an Ethernet).

The server 108 carries out post-processing depending on the data recorded. This may, for example, include analyzing the execution of the control software or analyzing the operation of the vehicle, in particular also by displaying the data for visual inspection by a user. Appropriate software tools can be used for this purpose, although they typically expect specific data formats. It is therefore necessary for the transmitted raw data to be brought into (i.e., converted to) a specific data format. This conversion in turn depends on the format in which information is contained in the raw data, i.e., how the raw data were generated from the corresponding information (e.g., measured values and log messages from the control software, etc.). The server 108 must therefore carry out a format conversion. For example, the server 108 executes analysis software that expects ROS (robot operating system) data.

Generating or parameterizing data conversion routines that convert data from a source format to a target format requires information about the structure (i.e., the layout) of the respective formats. For example, generating conversion routines for a format conversion (offline in the server 108 or possibly online in the vehicle 101, for example in order to display data on a display in the vehicle) requires knowledge of the source code of the control program 107 that generates the raw data and of the tools used to generate the control program 107. However, this is not readily given in some cases, for example because it is desirable to develop measurement systems and systems for analyzing measurement data independently of one another and at different times, for example because conversion routines are only required when the data are fed to the server 108 (e.g., downloaded from a cloud storage to which the data are transmitted first) or when a developer requests the data for analysis purposes and their software tool requires a specific format.

According to various embodiments, instead of generating conversion routines for data, provided by software, together with the generation of the software itself, an approach is therefore provided in which conversion routines are automatically generated on the receiver side (e.g., in the server 108) from meta-information about data formats (e.g., data structures, for example C++ data structures) used by the sending data processing device for the raw data (i.e., according to which the raw data are structured, i.e., information is contained (arranged or encoded) in the raw data). It should be noted that the layout of the raw data also depends on the corresponding compiler and the corresponding hardware. Before the conversion, translation into the layout of the machine that carries out the conversion must therefore also take place first so that the corresponding conversion routine works. This is done generically according to various embodiments (keyword ABI, i.e., memory alignment, padding, byte order, . . . ).

The meta-information is provided together with the raw data (e.g., in a common data stream). A generated conversion routine can use standard rules to reconstruct the original information in a target format or use user-defined rules to optimize the conversion (e.g., use specialized target data types for the conversion if necessary). The meta-information makes deserialization of the raw data on the receiver side (e.g., server 108) into a target format possible.

According to various embodiments, a conversion routine is thus generated for self-describing data (raw data plus meta-information) on the receiver side without the need for information about the generation process of the software that generates the raw data. The generation of the conversion routine can take place in response to the reception of the data in the receiver (i.e., for example, on the fly). The prerequisite is that the receiver has rules on how to interpret and convert all data types used for the raw data. It implements this rule in a conversion routine in the form of a conversion plugin, which a converter (i.e., data converter) of the receiver uses to convert received raw data to the target data format.

According to various embodiments, a generator is thus provided first, which (in a generator phase) generates one or more conversion routines, which are then used by a converter (in a conversion phase) to convert received raw data.

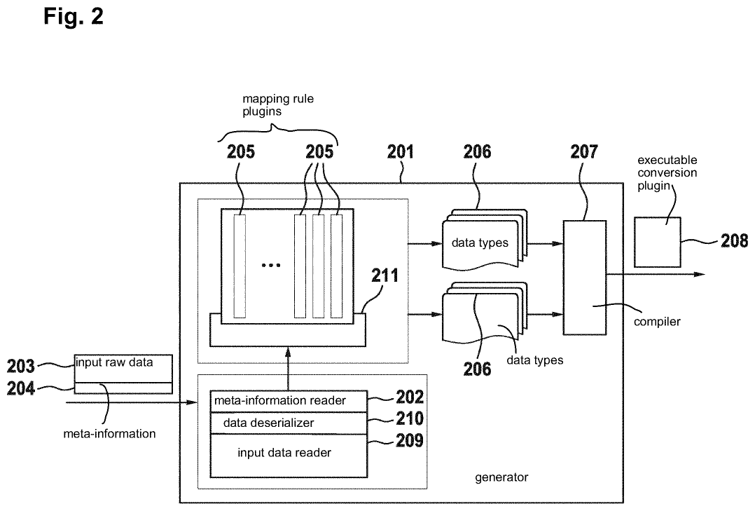

FIG. 2 illustrates the generator phase carried out by a generator 201.

The generator phase can also be considered a bootstrapping phase. From a reader for meta-information 204, a generator 201 receives information about data formats in which information is contained in input raw data 203. This information is attached as meta-information to the input raw data 204 (e.g., contained together with the input raw data 203 in an input data stream).

The generator 201 is a conversion plugin generator, i.e., it generates conversion routines in the form of conversion plugins 203. For this purpose, the generator 201 ascertains the data types used for the input raw data 203 and how the input raw data 203 are to be read and converted. The generator controller 211 receives program code for a corresponding mapping rule for a specific data type from an associated mapping rule plugin of a set of mapping rule plugins 205 with which the generator 201 is provided. The use of mapping rule plugins 205 to define mapping rules makes user extensibility possible. The mapping rule plugins generate source code for converting a data type to the target format and are, for example, executable templates.

From the source codes for converting data types used by a data structure according to which the raw data are structured, the generator generates source code for converting the data structure to the target format. This source coder receives the source code for converting the data types 206 (e.g., C++ to ROS, conversion source code for a plurality of data types) on the one hand and further additional source code 211 for one-off activities that are available for converting to the target format, e.g., for initializing data elements (e.g., messages) for the target format.

The generator controller 211 then feeds the source code 206, 211 to a compiler 207, which generates an executable conversion plugin 208 (which the converter can load directly) therefrom.

There are thus mapping plugins 205, which define the mapping rules and generate corresponding conversion source code for data types and which are used in the generator phase (e.g., as Python code with Jinja templating), and the converter plugins 203, which are generated in the generator phase by the generator 201 (e.g., from optimized C++ code, in order to achieve a high data set) and are used in the conversion phase.

The target data format is, for example, ROS messages.

Ascertaining the one or more data structures used for the raw data 203 can be considered a reflection mechanism. The meta-information reader 202 reads the meta-information from deserialized input data provided by an input data reader 209 followed by a data deserializer 210. For example, these units use a deserialization framework that contains tools and libraries for deserializing data streams containing raw C++ objects, with a source ABI (i.e., captured directly from the memory). It can be deserialized into any data format by using a reflection mechanism. This framework makes it possible to process raw C++ data without the need for serialization on the part of the sending data processing device. According to one embodiment, the deserialization framework uses so-called class info and ABI flags to describe data type (standard) layouts and class hashes to identify the data type layouts. Autonomy can be achieved by inserting this information into the recording stream for deserialization in the corresponding log data sink. Here, they are provided to the meta-information reader 202.

The meta-information reader 202 uses, for example, the deserialization framework to construct, for example, ASTs (abstract syntax trees) from the meta-information 204 and to provide them to the generator 201.

The conversion plugins generated by the generator 201 provide, for example, name mappings for C++ data types and name spaces and logic for generating copy commands (e.g., memcpy commands) for converting deserialized raw data to corresponding objects of the target data format (e.g., ROS message objects).

For example, the generator 201 generates, as input for the compiler 207,
code 211 from ROS packets for generating ROS messages according to the data types used in the raw data
C++ conversion code 206 and a CMake project for generating the conversion plugins
an auxiliary script for simply compiling the ROS packet code and the code for the conversion plugins

According to one embodiment, the generator 201 generates a conversion plugin 208 for each data structure (e.g., each C++ root type) used in the raw data 203 and a file for exporting the conversion plugin 208 so that a dynamic loader can find it.

For example, the generator 201 may be configured such that it can generate a conversion plugin 208 for any C++ data structure. It can recursively break C++ structures (structs) down to primitives or data types for which it has a mapping plugin 205. In this way, the generator 201 generates a routine for converting to the target format for each data type it encounters in the recursive process.

Since, according to various embodiments, the input data, i.e., raw data 203 and meta-information 204, are self-contained both in the offline case (e.g., a file or a file data stream) and in the online case (socket data stream), the generator 201 can generate the conversion plugin (or a plurality of conversion plugins) when (i.e., as soon as or only when) it (e.g., a receiver, e.g., server implementing the generator 201) receives the input data.

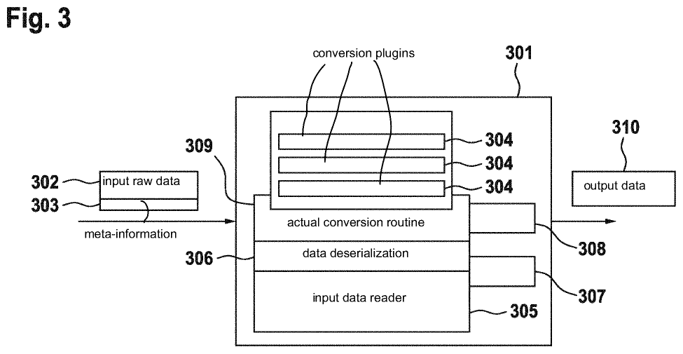

The generator 201 provides the conversion plugin 208 to the converter. The result is a converter equipped with conversion plugins, as shown in FIG. 3.

FIG. 3 illustrates the conversion phase carried out by a converter 301.

The converter 301 receives input raw data 302 provided with meta-information 303. The converter 301 is, for example, implemented as a precompiled executable program that dynamically loads (e.g., as a shared library) the conversion plugins 208, 304 generated by the generator 201 (according to the meta-information 204, 303).

The converter 301 comprises an input data reader 305 and a data deserializer 306, which, for example, use the aforementioned deserialization framework 307. The converter 301 furthermore comprises the actual conversion routine 309, which uses the conversion plugins 304 and, depending on the target format, possibly a library 308 to generate the target format (e.g., roscpp).

In order to identify the correct conversion plugin 304 for a data structure, the conversion routine 309 uses, for example, the class hash of the data structure (e.g., a C++ class hash), i.e., for example, a hash of the AST of the data structure (e.g., the class).

For a set of input data, the conversion plugins 304 only need to be generated once as long as the AST of the data type does not change. Even small changes, such as changes in names or components or a parent class of a class (which at first glance should not disturb the conversion), can lead to a changed class hash. On the other hand, there are also smaller changes that do not change the class hash (because they do not affect the ABI (application binary interface), e.g., the C++ ABI).

The conversion framework formed by the conversion routine 309 by means of the conversion plugins 304 generates output data (e.g., an output data stream) 310 in the target format. This output data stream can be stored directly (e.g., in a ROS bag file in the case of ROS), e.g., during offline transmission and offline analysis, or be received and processed by other components in a network, e.g., during online transmission and online analysis.

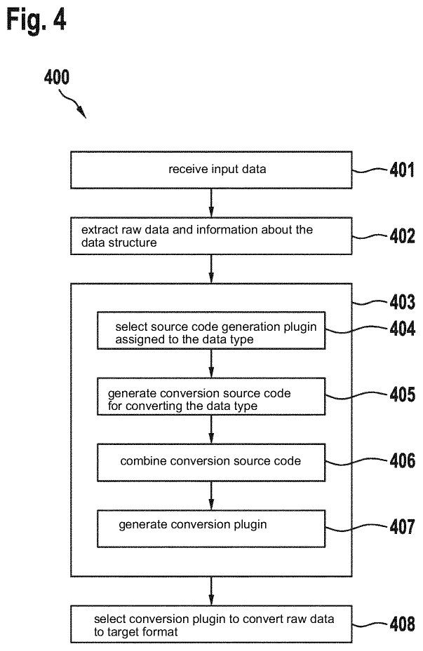

In summary, according to various embodiments, a data processing device is provided, which carries out a method as shown in FIG. 4.

FIG. 4 shows a flowchart 400 representing a method for converting data according to one embodiment.

In 401, input data are received.

In 402, raw data and information about a data structure according to which the raw data are structured are extracted from the input data, wherein the data structure contains a plurality of data types specified by the information.

In 403, for at least one data type used by the data structure,
in 404, a source code generation plugin assigned to the data type is selected from a plurality of source code generation plugins. (Each of the plurality of source code generation plugins is assigned to a corresponding data type);
in 405, conversion source code for converting the data type to a (specified or predefined) target format is generated by means of the selected source code generation plugin;
in 406, the conversion source code for converting the data types to the target format is combined to form conversion source code for converting the data structure to the target format; and
in 407, a conversion plugin for converting the data structure to the target format is generated by means of compilation of the conversion source code for converting the data structure to the target format.

In 408, the conversion plugin is selected and the raw data are thus converted to the target format.

The method in FIG. 4 can be carried out by one or more data processing devices (e.g., computers) with one or more data processing units. The term “data processing unit” may be understood as any type of entity that enables processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g., implemented) by a data processing unit by one or more special functions that are performed by the data processing unit.

The approach of FIG. 4 is used, for example, to receive data from a robot mechanism. The term “robot mechanism” may be understood to refer to any technical system, such as a computer-controlled machine, a vehicle, a household appliance, a power tool, a production machine, a personal assistant or an access control system.

Although specific embodiments have been depicted and described herein, a person skilled in the art will recognize that the specific embodiments shown and described may be replaced with a variety of alternative and/or equivalent implementations without departing from the scope of protection of the present invention. This application is intended to cover any adaptations or variations of the specific embodiments discussed herein.

1-8. (canceled)

9. A data processing device, comprising:
an input interface configured to receive input data and extract, from the input data, raw data and information about a data structure according to which the raw data are structured, wherein the data structure contains a plurality of data types specified by the information;
a generator configured to, for at least one data type used by the data structure:
select a source code generation plugin, assigned to the data type, from a plurality of source code generation plugins,
generate, using the selected source code generation plugin, conversion source code for converting the data type to a target format,
combine the conversion source code for converting the data type to the target format to form conversion source code for converting the data structure to the target format, and
generate, by means of compilation using the conversion source code for converting the data structure to the target format, a conversion plugin for converting the data structure to the target format; and
a converter configured to execute the conversion plugin to convert the raw data to the target format.

10. The data processing device according to claim 9, wherein the information about the data structure specifies a syntax tree of the data structure.

11. The data processing device according to claim 9, wherein the input data for each data structure of a plurality of data structures contain raw data structured according to the data structure, and the generator is configured to generate a corresponding conversion plugin for each data structure, and the converter is configured to ascertain, for extracted raw data, according to which data structure they are structured and to execute the corresponding conversion plugin and thus to convert the raw data to the target format.

12. The data processing device according to claim 11, wherein the generator is configured to assign a hash value to each conversion plugin, and wherein the converter is configured to ascertain and execute a conversion plugin for converting raw data structured according to one of the data structures, by forming a hash value of a syntax tree of the data structure and selecting the conversion plugin to which the formed hash value is assigned.

13. The data processing device according to claim 9, wherein the raw data are: (i) measurement data, which are provided by a robot mechanism, and/or (ii) log data of an execution of a program on a robot mechanism.

14. A method for converting data, comprising the following steps:
receiving input data;
extracting, from the input data, raw data and information about a data structure according to which the raw data are structured, wherein the data structure contains a plurality of data types specified by the information;
for at least one data type used by the data structure,
selecting a source code generation plugin, assigned to the data type, from a plurality of source code generation plugins,
generating, using the selected source code generation plugin, conversion source code for converting the data type to a target format,
combining the conversion source code for converting the data type to the target format to form conversion source code for converting the data structure to the target format, and
generating, using compilation of the conversion source code for converting the data structure to the target format, a conversion plugin for converting the data structure to the target format; and
executing the conversion plugin to convert the raw data to the target format.

15. A non-transitory computer-readable medium on which is stored a computer program including instructions for converting data, the instructions, when executed by one or more processors, causing the one or more processors to perform the following steps:
receiving input data;
extracting, from the input data, raw data and information about a data structure according to which the raw data are structured, wherein the data structure contains a plurality of data types specified by the information;
for at least one data type used by the data structure,
selecting a source code generation plugin, assigned to the data type, from a plurality of source code generation plugins,
generating, using the selected source code generation plugin, conversion source code for converting the data type to a target format,
combining the conversion source code for converting the data type to the target format to form conversion source code for converting the data structure to the target format, and
generating, using compilation of the conversion source code for converting the data structure to the target format, a conversion plugin for converting the data structure to the target format; and
executing the conversion plugin to convert the raw data to the target format.
